(19) United States
(12) Patent Application Publication
(10) Pub. No.: US 2026/0205338 A1
(43) Pub. Date: Jul. 16, 2026

(54) METHOD AND APPARATUS FOR TRANSMITTING AND RECEIVING SIGNALS IN WIRELESS COMMUNICATION SYSTEM BY USING TRANSCEIVER HAVING ADJUSTABLE PARAMETERS

(71) Applicant: LG ELECTRONICS INC., Seoul (KR)

(72) Inventors: Yeongjun KIM, Seoul (KR); Bonghoe KIM, Seoul (KR); Kyungho LEE, Seoul (KR); Sangrim LEE, Seoul (KR)

(73) Assignee: LG ELECTRONICS INC., Seoul (KR)

(21) Appl. No.: 19/134,379

(22) PCT Filed: Nov. 30, 2022
(86) PCT No.: PCT/KR2022/019169

§ 371 Date: May 30, 2025

(51) Int. Cl. H04L 27/26; H04L 41/16

(52) U.S. Cl. CPC H04L 27/261; H04L 41/16

(57) ABSTRACT

Disclosed is a method for operating a user equipment (UE) to transmit and receive signals in a wireless communication system by using a transceiver having adjustable parameters, the method comprising the steps of: receiving, from a base station, configuration information related to reference signals; receiving the reference signals; generating feedback information by using the reference signals; and transmitting the feedback information to the base station. The feedback information may include information indicating a channel environment for determining adjustable parameters included in a receiver of the UE and a transmitter of the base station.

### CROSS-REFERENCE TO RELATED APPLICATION(S)

This application is the National Stage filing under 35 U.S.C. 371 of International Application No. PCT/KR2022/019169, filed on Nov. 30, 2022, the contents of which are all incorporated by reference herein in its entirety.

### TECHNICAL FIELD

The following description relates to a wireless communication system, and more particularly, to a device and method for transceiving signals using a transceiver having adjustable parameters in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure may provide a device and method for transceiving signals using a transceiver having adjustable parameters in a wireless communication system.

The present disclosure may provide a device and method for building a transceiver having adjustable parameters in a wireless communication system.

The present disclosure may provide a device and method for building a transceiver whose attributes vary depending on channel environments in a wireless communication system.

The present disclosure may provide a device and method for performing training of a transceiver model having attributes that vary depending on channel environments in a wireless communication system.

The present disclosure may provide a device and method for operating a transceiver model having attributes that vary depending on channel environments in a wireless communication system.

The present disclosure may provide a device and method for performing signaling for a transceiver model having attributes that vary depending on channel environments in a wireless communication system.

The present disclosure may provide a device and method for signaling information related to channel environments controlling attributes of a transceiver model in a wireless communication system.

The present disclosure may provide a device and method for converting information related to channel environments controlling attributes of a transceiver model in a wireless communication system.

The present disclosure may provide a device and method for signaling information related to a training type of a transceiver model in a wireless communication system.

The present disclosure may provide a device and method for converting information related to channel environments based on a training type of a transceiver model in a wireless communication system.

The technical objectives of the present disclosure are not limited to the aforementioned aspects, and other technical objectives not explicitly mentioned may be recognized by those skilled in the relevant art from the embodiments of the present disclosure described below.

According to an embodiment of the present disclosure, a method for operating a user equipment (UE) in a wireless communication system, the method may include: a transceiver including multiple transmitters and multiple receivers; and a processor connected to the transceiver, wherein the processor is configured to perform operations may include: receiving, from a base station, configuration information related to reference signals; receiving the reference signals; generating feedback information by using the reference signals; and transmitting, to the base station, the feedback information, wherein the feedback information includes information representing a channel environment for determining adjustable parameters included in a receiver of the UE and a transmitter of the base station.

According to an embodiment of the present disclosure, a method for operating a base station in a wireless communication system, the method may include: a transceiver including multiple transmitters and multiple receivers; and a processor connected to the transceiver, wherein the processor is configured to perform operations may include: receiving, from a base station, configuration information related to reference signals; receiving the reference signals; generating feedback information by using the reference signals; and transmitting, to the base station, the feedback information, wherein the feedback information includes information representing a channel environment for determining adjustable parameters included in a receiver of the UE and a transmitter of the base station.

According to an embodiment of the present disclosure, a user equipment (UE) in a wireless communication system, the UE may include: a transceiver; and a processor connected to the transceiver, wherein the processor is configured to perform operations may include: receiving, from a base station, configuration information related to reference signals; receiving the reference signals; generating feedback information by using the reference signals; and transmitting, to the base station, the feedback information, wherein the feedback information includes information representing a channel environment for determining adjustable parameters included in a receiver of the UE and a transmitter of the base station.

According to an embodiment of the present disclosure, a base station in a wireless communication system, the base station may include: a transceiver; and a processor connected to the transceiver, wherein the processor is configured to perform operations may include: receiving, from a base station, configuration information related to reference signals; receiving the reference signals; generating feedback information by using the reference signals; and transmitting, to the base station, the feedback information, wherein the feedback information includes information representing a channel environment for determining adjustable parameters included in a receiver of the UE and a transmitter of the base station.

According to an embodiment of the present disclosure, a communication device may include: at least one processor; a processor connected to the transceiver, at least one computer memory connected to the at least one processor and storing instructions that, based on being executed by the at least one processor, cause the device to perform operations, wherein the operations may include: receiving, from a base station, configuration information related to reference signals; receiving the reference signals; generating feedback information by using the reference signals; and transmitting, to the base station, the feedback information, wherein the feedback information includes information representing a channel environment for determining adjustable parameters included in a receiver of the UE and a transmitter of the base station. receiving, from a base station, configuration information related to reference signals; receiving the reference signals; generating feedback information by using the reference signals; and transmitting, to the base station, the feedback information, wherein the feedback information includes information representing a channel environment for determining adjustable parameters included in a receiver of the UE and a transmitter of the base station.

According to an embodiment of the present disclosure, a non-transitory computer-readable medium storing at least one instruction, comprising the at least one instruction being executable by a processor, wherein the at least one instruction is configured to perform operations may include:

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, a transceiver may be adaptively operated in various channel environments.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows another example of a wireless device applicable to the present disclosure.

FIG. 4 shows an example of a hand-held device applicable to the present disclosure.

FIG. 5 shows an example of a car or an autonomous driving car applicable to the present disclosure.

FIG. 6 shows an example of artificial intelligence (AI) device applicable to the present disclosure.

FIG. 7 shows a method of processing a transmitted signal applicable to the present disclosure.

FIG. 8 shows an example of a communication structure providable in a 6th generation (6G) system applicable to the present disclosure.

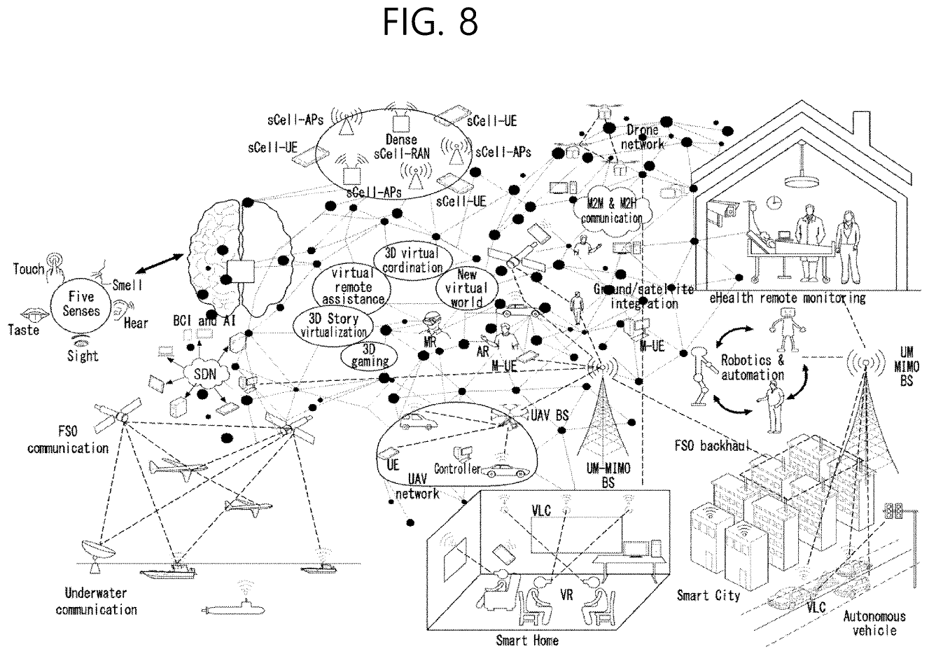

FIG. 9 shows an electromagnetic spectrum applicable to the present disclosure.

FIG. 10 shows a THz communication method applicable to the present disclosure.

FIG. 11 shows a perceptron architecture in an artificial neural network applicable to the present disclosure.

FIG. 12 shows an artificial neural network architecture applicable to the present disclosure.

FIG. 13 shows a deep neural network applicable to the present disclosure.

FIG. 14 shows a convolutional neural network applicable to the present disclosure.

FIG. 15 shows a filter operation of a convolutional neural network applicable to the present disclosure.

FIG. 16 shows a neural network architecture with a recurrent loop applicable to the present disclosure.

FIG. 17 shows an operational structure of a recurrent neural network applicable to the present disclosure.

FIGS. 18a and 18b show examples of methods for building DNNs for channel environments according to an embodiment of the present disclosure.

FIG. 19 shows examples of multi-task learning techniques.

FIG. 20 shows an example of task switching network (TSN) utilization.

FIG. 21 shows the concept of a DNN according to an embodiment of the present disclosure.

FIG. 22 shows an example of a structure of a DNN layer having adjustable parameters according to a channel environment during pre-training operation.

FIG. 23 shows an example of a neural network structure including a transmitting DNN and a receiving DNN according to an embodiment of the present disclosure.

FIG. 24 shows DNN operation based on updating a channel environment identifier according to an embodiment of the present disclosure.

FIGS. 25a and 25b show examples of stepwise training according to an embodiment of the present disclosure.

FIG. 26 shows examples of training types according to an embodiment of the present disclosure.

FIG. 27 shows an example of a procedure for transmitting signals using a transmitter according to an embodiment of the present disclosure.

FIG. 28 shows an example of a procedure for receiving signals using a receiver according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

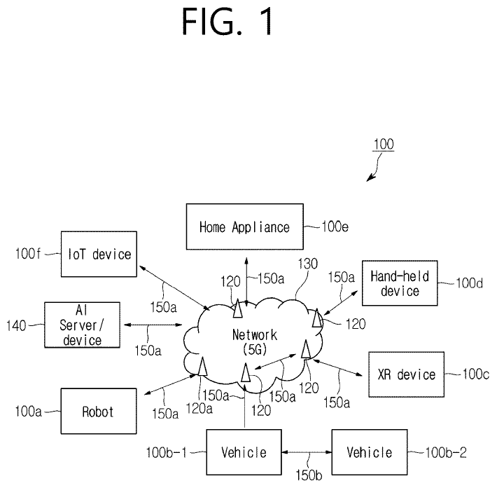

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100 a, vehicles 100 b-1 and 100 b-2, an extended reality (XR) device 100 c, a hand-held device 100 d, a home appliance 100 e, an Internet of Thing (IoT) device 100 f, and an artificial intelligence (AI) device/server 100 g. For example, the vehicles may include a vehicle having a wireless communication function, an autonomous vehicle, a vehicle capable of performing vehicle-to-vehicle communication, etc. The vehicles 100 b-1 and 100 b-2 may include an unmanned aerial vehicle (UAV) (e.g., a drone). The XR device 100 c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100 d may include a smartphone, a smart pad, a wearable device (e.g., a smart watch or smart glasses), a computer (e.g., a laptop), etc. The home appliance 100 e may include a TV, a refrigerator, a washing machine, etc. The IoT device 100 f may include a sensor, a smart meter, etc. For example, the base station 120 and the network 130 may be implemented by a wireless device, and a specific wireless device 120 a may operate as a base station/network node for another wireless device.

The wireless devices 100 a to 100 f may be connected to the network 130 through the base station 120. AI technology is applicable to the wireless devices 100 a to 100 f, and the wireless devices 100 a to 100 f may be connected to the AI server 100 g through the network 130. The network 130 may be configured using a 3G network, a 4G (e.g., LTE) network or a 5G (e.g., NR) network, etc. The wireless devices 100 a to 100 f may communicate with each other through the base station 120/the network 130 or perform direct communication (e.g., sidelink communication) without through the base station 120/the network 130. For example, the vehicles 100 b-1 and 100 b-2 may perform direct communication (e.g., vehicle to vehicle (V2V)/vehicle to everything (V2X) communication). In addition, the IoT device 100 f (e.g., a sensor) may perform direct communication with another IoT device (e.g., a sensor) or the other wireless devices 100 a to 100 f.

Wireless communications/connections 150 a, 150 b and 150 c may be established between the wireless devices 100 a to 100 f/the base station 120 and the base station 120/the base station 120. Here, wireless communication/connection may be established through various radio access technologies (e.g., 5G NR) such as uplink/downlink communication 150 a, sidelink communication 150 b (or D2D communication) or communication 150 c between base stations (e.g., relay, integrated access backhaul (IAB). The wireless device and the base station/wireless device or the base station and the base station may transmit/receive radio signals to/from each other through wireless communication/connection 150 a, 150 b and 150 c. For example, wireless communication/connection 150 a, 150 b and 150 c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

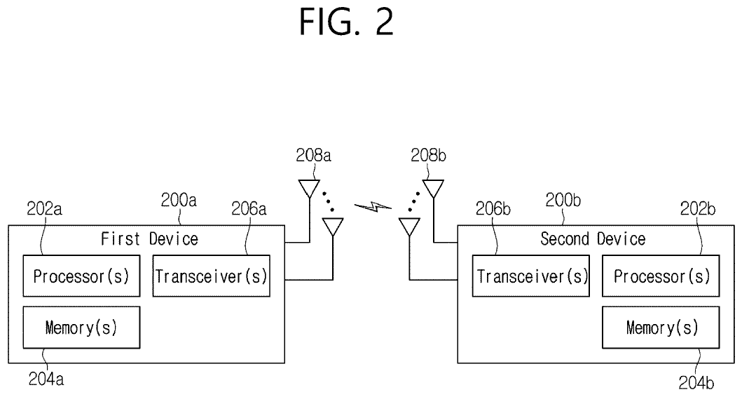

FIG. 2 shows an example of a wireless device applicable to the present disclosure.

Referring to FIG. 2, a first wireless device 200 a and a second wireless device 200 b may transmit and receive radio signals through various radio access technologies (e.g., LTE or NR). Here, (the first wireless device 200 a, the second wireless device 200 b) may correspond to (the wireless device 100 x, the base station 120) and/or (the wireless device 100 x, the wireless device 100 x) of FIG. 1.

The first wireless device 200 a may include one or more processors 202 a and one or more memories 204 a and may further include one or more transceivers 206 a and/or one or more antennas 208 a. The processor 202 a may be configured to control the memory 204 a and/or the transceiver 206 a and to implement descriptions, functions, procedures, proposals, methods and/or operational flowcharts disclosed herein. For example, the processor 202 a may process information in the memory 204 a to generate first information/signal and then transmit a radio signal including the first information/signal through the transceiver 206 a. In addition, the processor 202 a may receive a radio signal including second information/signal through the transceiver 206 a and then store information obtained from signal processing of the second information/signal in the memory 204 a. The memory 204 a may be coupled with the processor 202 a, and store a variety of information related to operation of the processor 202 a. For example, the memory 204 a may store software code including instructions for performing all or some of the processes controlled by the processor 202 a or performing the descriptions, functions, procedures, proposals, methods and/or operational flowcharts disclosed herein. Here, the processor 202 a and the memory 204 a may be part of a communication modem/circuit/chip designed to implement wireless communication technology (e.g., LTE or NR). The transceiver 206 a may be coupled with the processor 202 a to transmit and/or receive radio signals through one or more antennas 208 a. The transceiver 206 a may include a transmitter and/or a receiver. The transceiver 206 a may be used interchangeably with a radio frequency (RF) unit. In the present disclosure, the wireless device may refer to a communication modem/circuit/chip.

The second wireless device 200 b may include one or more processors 202 b and one or more memories 204 b and may further include one or more transceivers 206 b and/or one or more antennas 208 b. The processor 202 b may be configured to control the memory 204 b and/or the transceiver 206 b and to implement the descriptions, functions, procedures, proposals, methods and/or operational flowcharts disclosed herein. For example, the processor 202 b may process information in the memory 204 b to generate third information/signal and then transmit the third information/signal through the transceiver 206 b. In addition, the processor 202 b may receive a radio signal including fourth information/signal through the transceiver 206 b and then store information obtained from signal processing of the fourth information/signal in the memory 204 b. The memory 204 b may be coupled with the processor 202 b to store a variety of information related to operation of the processor 202 b. For example, the memory 204 b may store software code including instructions for performing all or some of the processes controlled by the processor 202 b or performing the descriptions, functions, procedures, proposals, methods and/or operational flowcharts disclosed herein. Herein, the processor 202 b and the memory 204 b may be part of a communication modem/circuit/chip designed to implement wireless communication technology (e.g., LTE or NR).

The transceiver 206 b may be coupled with the processor 202 b to transmit and/or receive radio signals through one or more antennas 208 b. The transceiver 206 b may include a transmitter and/or a receiver. The transceiver 206 b may be used interchangeably with a radio frequency (RF) unit. In the present disclosure, the wireless device may refer to a communication modem/circuit/chip.

Hereinafter, hardware elements of the wireless devices 200 a and 200 b will be described in greater detail. Without being limited thereto, one or more protocol layers may be implemented by one or more processors 202 a and 202 b. For example, one or more processors 202 a and 202 b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202 a and 202 b may generate one or more protocol data units (PDUs) and/or one or more service data unit (SDU) according to the descriptions, functions, procedures, proposals, methods and/or operational flowcharts disclosed herein. One or more processors 202 a and 202 b may generate messages, control information, data or information according to the descriptions, functions, procedures, proposals, methods and/or operational flowcharts disclosed herein. One or more processors 202 a and 202 b may generate PDUs, SDUs, messages, control information, data or information according to the functions, procedures, proposals and/or methods disclosed herein and provide the PDUs, SDUs, messages, control information, data or information to one or more transceivers 206 a and 206 b. One or more processors 202 a and 202 b may receive signals (e.g., baseband signals) from one or more transceivers 206 a and 206 b and acquire PDUs, SDUs, messages, control information, data or information according to the descriptions, functions, procedures, proposals, methods and/or operational flowcharts disclosed herein.

One or more processors 202 a and 202 b may be referred to as controllers, microcontrollers, microprocessors or microcomputers. One or more processors 202 a and 202 b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202 a and 202 b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202 a and 202 b or stored in one or more memories 204 a and 204 b to be driven by one or more processors 202 a and 202 b. The descriptions, functions, procedures, proposals, methods and/or operational flowcharts disclosed herein implemented using firmware or software in the form of code, a command and/or a set of commands.

One or more memories 204 a and 204 b may be coupled with one or more processors 202 a and 202 b to store various types of data, signals, messages, information, programs, code, instructions and/or commands. One or more memories 204 a and 204 b may be composed of read only memories (ROMs), random access memories (RAMs), erasable programmable read only memories (EPROMs), flash memories, hard drives, registers, cache memories, computer-readable storage mediums and/or combinations thereof. One or more memories 204 a and 204 b may be located inside and/or outside one or more processors 202 a and 202 b. In addition, one or more memories 204 a and 204 b may be coupled with one or more processors 202 a and 202 b through various technologies such as wired or wireless connection.

One or more transceivers 206 a and 206 b may transmit user data, control information, radio signals/channels, etc. described in the methods and/or operational flowcharts of the present disclosure to one or more other apparatuses. One or more transceivers 206 a and 206 b may receive user data, control information, radio signals/channels, etc. described in the methods and/or operational flowcharts of the present disclosure from one or more other apparatuses. For example, one or more transceivers 206 a and 206 b may be coupled with one or more processors 202 a and 202 b to transmit/receive radio signals. For example, one or more perform processors 202 a and 202 b may control such that one or more transceivers 206 a and 206 b transmit user data, control information or radio signals to one or more other apparatuses. In addition, one or more processors 202 a and 202 b may perform control such that one or more transceivers 206 a and 206 b receive user data, control information or radio signals from one or more other apparatuses. In addition, one or more transceivers 206 a and 206 b may be coupled with one or more antennas 208 a and 208 b, and one or more transceivers 206 a and 206 b may be configured to transmit/receive user data, control information, radio signals/channels, etc. described in the descriptions, functions, procedures, proposals, methods and/or operational flowcharts disclosed herein through one or more antennas 208 a and 208 b. In the present disclosure, one or more antennas may be a plurality of physical antennas or a plurality of logical antennas (e.g., antenna ports). One or more transceivers 206 a and 206 b may convert the received radio signals/channels, etc. from RF band signals to baseband signals, in order to process the received user data, control information, radio signals/channels, etc. using one or more processors 202 a and 202 b. One or more transceivers 206 a and 206 b may convert the user data, control information, radio signals/channels processed using one or more processors 202 a and 202 b from baseband signals into RF band signals. To this end, one or more transceivers 206 a and 206 b may include (analog) oscillator and/or filters.

### Structure of Wireless Device Applicable to the Present Disclosure

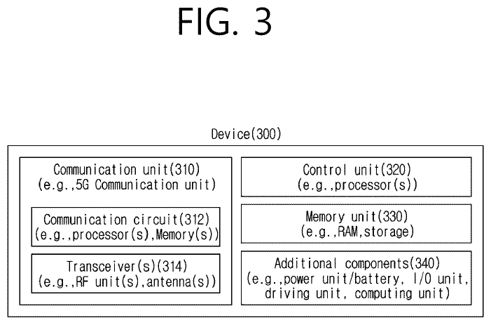

FIG. 3 shows another example of a wireless device applicable to the present disclosure.

Referring to FIG. 3, a wireless device 300 may correspond to the wireless devices 200 a and 200 b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202 a and 202 b and/or one or more memories 204 a and 204 b of FIG. 2. For example, the transceiver(s) 314 may include one or more transceivers 206 a and 206 b and/or one or more antennas 208 a and 208 b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100 a), the vehicles (FIGS. 1, 100 b-1 and 100 b-2), the XR device (FIG. 1, 100 c), the hand-held device (FIG. 1, 100 d), the home appliance (FIG. 1, 100 e), the IoT device (FIG. 1, 100 f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

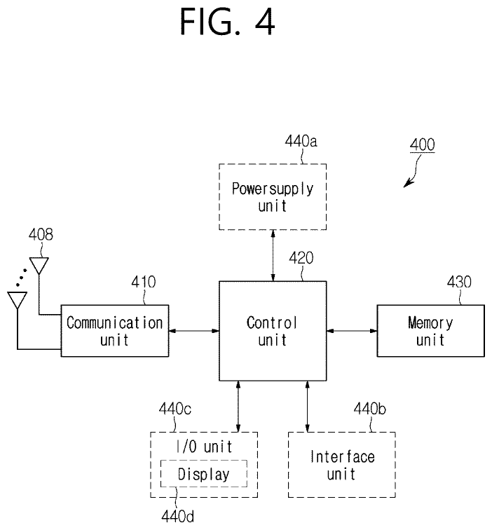

FIG. 4 shows an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440 a, an interface unit (interface) 440 b, and an input/output unit 440 c. An antenna unit (antenna) 408 may be part of the communication unit 410. The blocks 410 to 430/440 a to 440 c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440 a may supply power to the hand-held device 400 and include a wired/wireless charging circuit, a battery, etc. The interface unit 440 b may support connection between the hand-held device 400 and another external device. The interface unit 440 b may include various ports (e.g., an audio input/output port and a video input/output port) for connection with the external device. The input/output unit 440 c may receive or output video information/signals, audio information/signals, data and/or user input information. The input/output unit 440 c may include a camera, a microphone, a user input unit, a display 440 d, a speaker and/or a haptic module.

For example, in case of data communication, the input/output unit 440 c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440 c in various forms (e.g., text, voice, image, video and haptic).

### Type of Wireless Device Applicable to the Present Disclosure

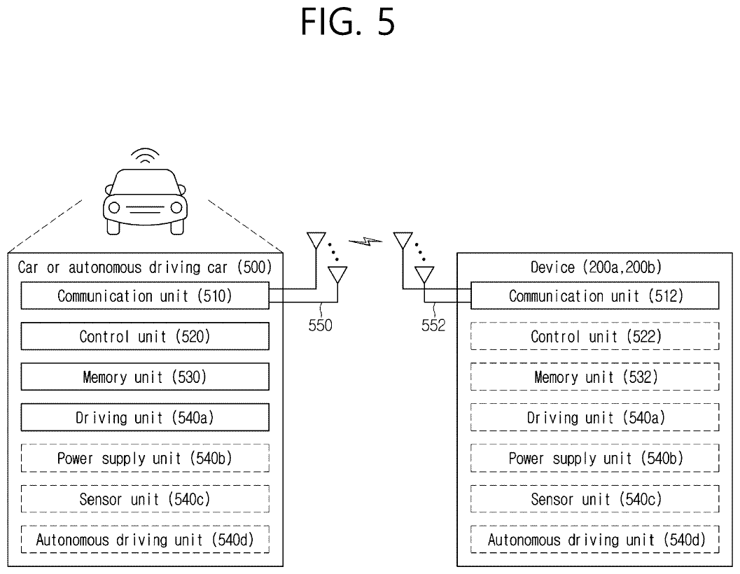

FIG. 5 shows an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540 a, a power supply unit (power supply) 540 b, a sensor unit 540 c, and an autonomous driving unit 540 d. The antenna unit 550 may be configured as part of the communication unit 510. The blocks 510/530/540 a to 540 d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

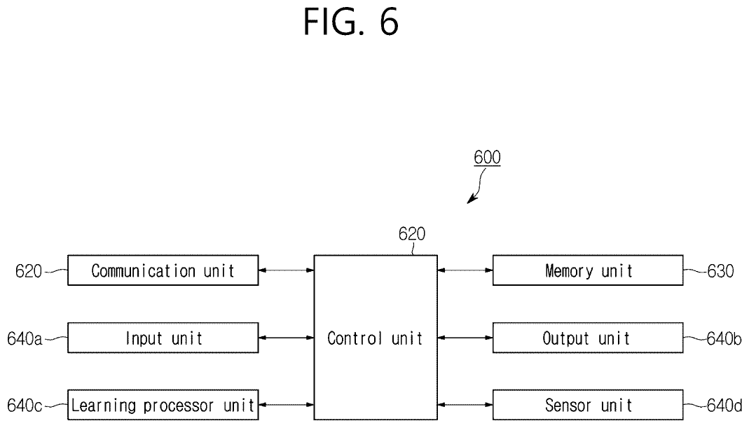

FIG. 6 shows an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640 a/640 b, a leaning processor unit (learning processor) 640 c and a sensor unit 640 d. The blocks 610 to 630/640 a to 640 d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100 x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640 c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640 c or transmit the history information to the AI server (FIG. 1, 140). The collected history information may be used to update a learning model.

The memory unit 630 may store data supporting various functions of the AI device 600. For example, the memory unit 630 may store data obtained from the input unit 640 a, data obtained from the communication unit 610, output data of the learning processor unit 640 c, and data obtained from the sensing unit 640. In addition, the memory unit 630 may store control information and/or software code necessary to operate/execute the control unit 620.

The input unit 640 a may acquire various types of data from the outside of the AI device 600. For example, the input unit 640 a may acquire learning data for model learning, input data, to which the learning model will be applied, etc. The input unit 640 a may include a camera, a microphone and/or a user input unit. The output unit 640 b may generate video, audio or tactile output. The output unit 640 b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640 c may train a model composed of an artificial neural network using training data. The learning processor unit 640 c may perform AI processing along with the learning processor unit of the AI server (FIG. 1, 140). The learning processor unit 640 c may process information received from an external device through the communication unit 610 and/or information stored in the memory unit 630. In addition, the output value of the learning processor unit 640 c may be transmitted to the external device through the communication unit 610 and/or stored in the memory unit 630.

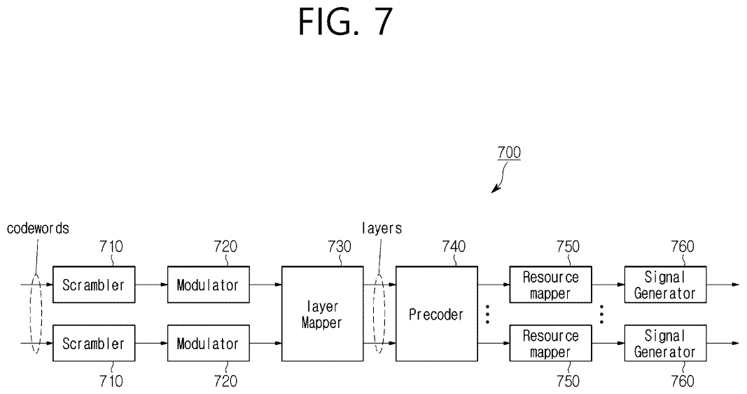

FIG. 7 shows a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202 a and 202 b and/or the transceiver 206 a and 206 b of FIG. 2. In addition, for example, the hardware element of FIG. 7 may be implemented in the processors 202 a and 202 b of FIG. 2 and/or the transceivers 206 a and 206 b of FIG. 2. For example, blocks 710 to 760 may be implemented in the processors 202 a and 202 b of FIG. 2. In addition, blocks 710 to 750 may be implemented in the processors 202 a and 202 b of FIG. 2 and a block 760 may be implemented in the transceivers 206 a and 206 b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200 a or 200 b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |
| Mobility support | Up to 1000 | km/hr |

| | |
|---|---|
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

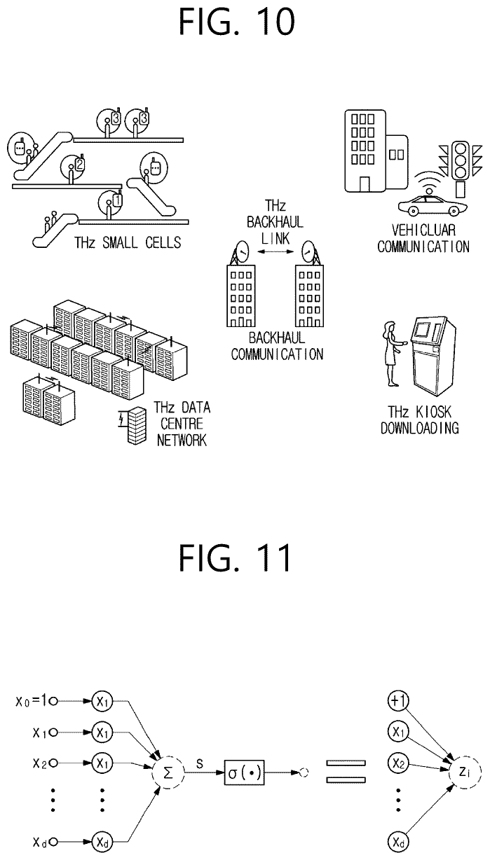

FIG. 10 shows an example of a communication structure providable in a 6G system applicable to the present disclosure.

Referring to FIG. 10, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel measurement and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

### Terahertz (THz) Communication

THz communication is applicable to the 6G system. For example, a data rate may increase by increasing bandwidth. This may be performed by using sub-THz communication with wide bandwidth and applying advanced massive MIMO technology.

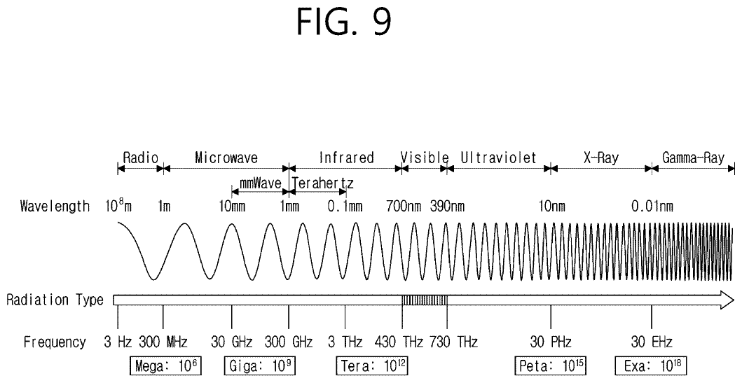

FIG. 9 shows an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

FIG. 10 shows a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Artificial Intelligence System

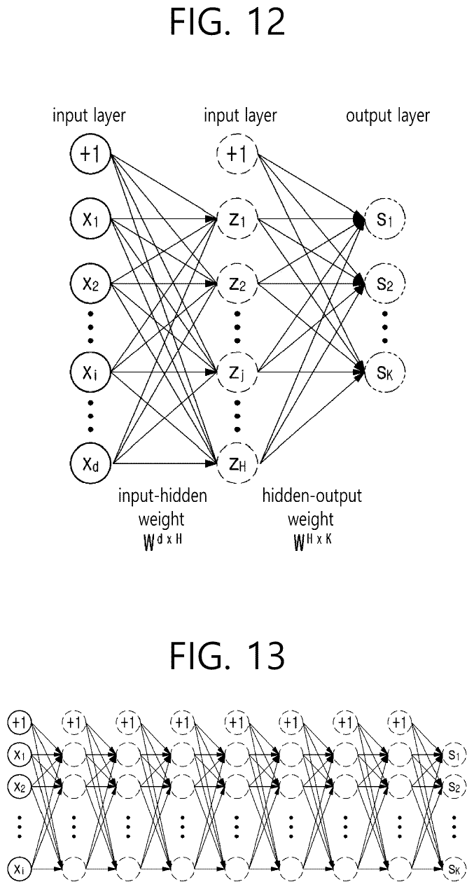

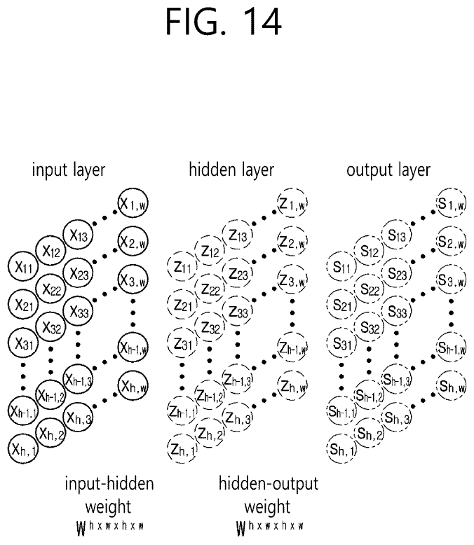

FIG. 11 shows a perceptron architecture in an artificial neural network applicable to the present disclosure. In addition, FIG. 12 shows an artificial neural network architecture applicable to the present disclosure.

As described above, an artificial intelligence system may be applied to a 6G system. Herein, as an example, the artificial intelligence system may operate based on a learning model corresponding to the human brain, as described above. Herein, a paradigm of machine learning, which uses a neural network architecture with high complexity like artificial neural network, may be referred to as deep learning. In addition, neural network cores, which are used as a learning scheme, are mainly a deep neural network (DNN), a convolutional deep neural network (CNN), and a recurrent neural network (RNN). Herein, as an example referring to FIG. 11, an artificial neural network may consist of a plurality of perceptrons. Herein, when an input vector x={x₁, x₂, . . . , x_{d}} is input, each component is multiplied by a weight {W₁, W₂, . . . , Wd}, results are all added up, and then an activation function σ(⋅) is applied, of which the overall process may be referred to as a perceptron. For a large artificial neural network architecture, when expanding the simplified perceptron structure illustrated in FIG. 11, an input may be applied to different multidimensional perceptrons. For convenience of explanation, an input value or an output value will be referred to as a node.

Meanwhile, the perceptron structure shown in FIG. 11 may be described to consist of a total of 3 layers based on an input value and an output value. An artificial neural network, which has H (d+1)-dimensional perceptrons between the 1^{st} layer and the 2^{nd} layer and K (H+1)-dimensional perceptrons between the 2^{nd} layer and the 3rd layer, may be expressed as in FIG. 12.

Herein, a layer, in which an input vector is located, is referred to as an input layer, a layer, in which a final output value is located, is referred to as an output layer, and all the layers between the input layer and the output layer are referred to as hidden layers. As an example, 3 layers are disclosed in FIG. 12, but since an input layer is excluding in counting the number of actual artificial neural network layers, it can be understood that the artificial neural network shown in FIG. 12 has a total of 2 layers. An artificial neural network is constructed by connecting perceptrons of a basic block two-dimensionally.

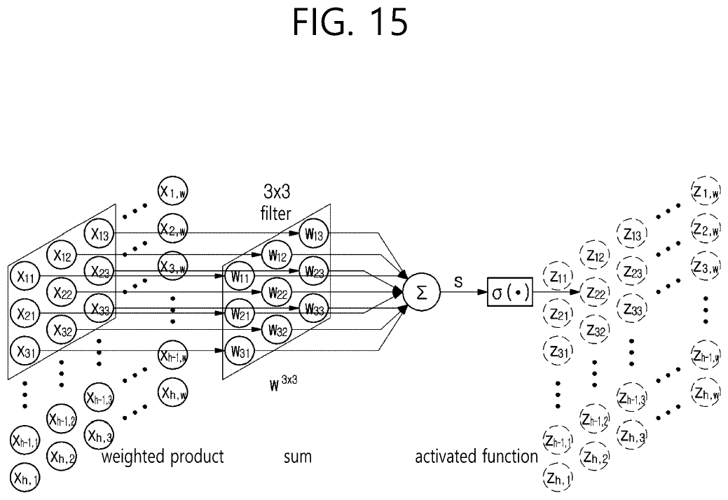

The above-described input layer, hidden layer and output layer are commonly applicable not only to multilayer perceptrons but also to various artificial neural network architectures like CNN and RNN, which will be described below. As there are more hidden layers, an artificial neural network becomes deeper, and a machine learning paradigm using a sufficiently deep artificial neural network as a learning model may be referred to as deep learning. In addition, an artificial neural network used for deep learning may be referred to as a deep neural network (DNN). FIG. 13 shows a deep neural network applicable to the present disclosure.

Referring to FIG. 13, a deep neural network may be a multilayer perceptron consisting of 8 layers (hidden layers+output layer). Herein, the multilayer perceptron structure may be expressed as a fully-connected neural network. In a fully-connected neural network, there may be no connection between nodes in a same layer and only nodes located in neighboring layers may be connected with each other. A DNN has a fully-connected neural network structure combining a plurality of hidden layers and activation functions so that it may be effectively applied for identifying a correlation characteristic between an input and an output. Herein, the correlation characteristic may mean a joint probability between the input and the output.

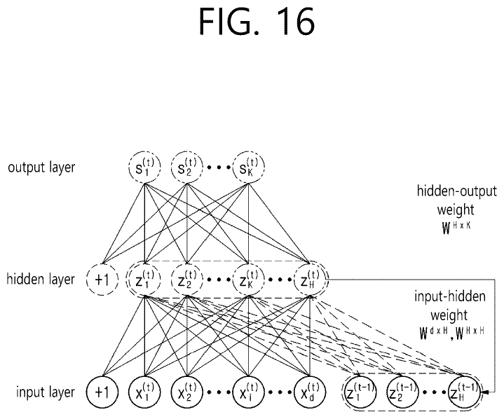

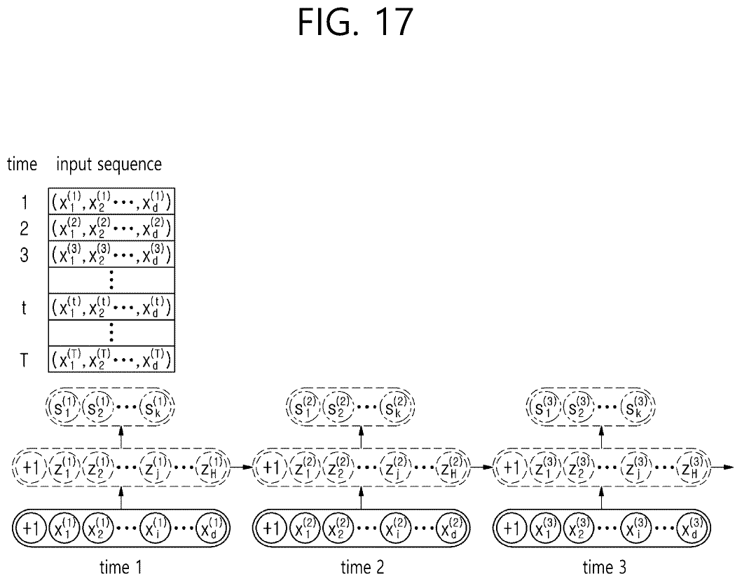

FIG. 14 shows a convolutional neural network applicable to the present disclosure. In addition, FIG. 15 shows a filter operation of a convolutional neural network applicable to the present disclosure.

As an example, depending on how to connect a plurality of perceptrons, it is possible to form various artificial neural network structures different from the above-described DNN. Herein, in the DNN, nodes located in a single layer are arranged in a one-dimensional vertical direction. However, referring to FIG. 14, it is possible to assume a two-dimensional array of w horizontal nodes and h vertical nodes (the convolutional neural network structures of FIG. 14). In this case, since a weight is applied to each connection in a process of connecting one input node to a hidden layer, a total of hxw weights should be considered. As there are hxw nodes in an input layer, a total of h²w² weights may be needed between two neighboring layers.

Furthermore, as the convolutional neural network of FIG. 14 has the problem of exponential increase in the number of weights according to the number of connections, the presence of a small filter may be assumed instead of considering every mode of connections between neighboring layers. As an example, as shown in FIG. 15, weighted summation and activation function operation may be enabled for a portion overlapped by a filter.

At this time, one filter has a weight corresponding to a number as large as its size, and learning of a weight may be performed to extract and output a specific feature on an image as a factor. In FIG. 15, a 3×3 filter may be applied to a top rightmost 3×3 area of an input layer, and an output value, which is a result of the weighted summation and activation function operation for a corresponding node, may be stored at z₂₂.

Herein, as the above-described filter scans the input layer while moving at a predetermined interval horizontally and vertically, a corresponding output value may be put a position of a current filter. Since a computation method is similar to a convolution computation for an image in the field of computer vision, such a structure of deep neural network may be referred to as a convolutional neural network (CNN), and a hidden layer created as a result of convolution computation may be referred to as a convolutional layer. In addition, a neural network with a plurality of convolutional layers may be referred to as a deep convolutional neural network (DCNN).

In addition, at a node in which a current filter is located in a convolutional layer, a weighted sum is calculated by including only a node in an area covered by the filter and thus the number of weights may be reduced. Accordingly, one filter may be so used as to focus on a feature of a local area. Thus, a CNN may be effectively applied to image data processing for which a physical distance in a two-dimensional area is a crucial criterion of determination. Meanwhile, a CNN may apply a plurality of filters immediately before a convolutional layer and create a plurality of output results through a convolution computation of each filter.

Meanwhile, depending on data properties, there may be data of which a sequence feature is important. A recurrent neural network structure may be a structure obtained by applying a scheme, in which elements in a data sequence are input one by one at each timestep by considering the distance variability and order of such sequence datasets and an output vector (hidden vector) output at a specific timestep is input with a very next element in the sequence, to an artificial neural network.

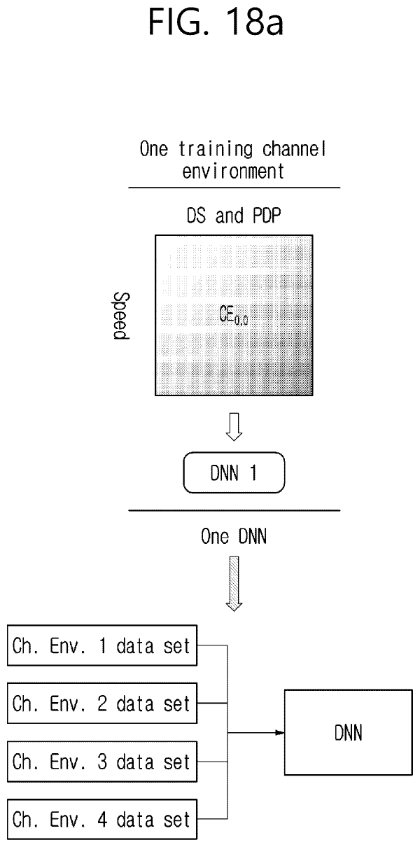

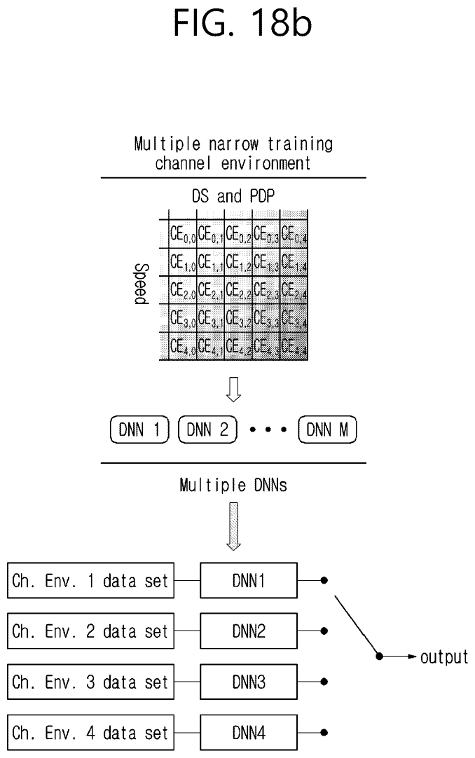

FIG. 16 shows a neural network architecture with a recurrent loop applicable to the present disclosure. FIG. 17 shows an operational structure of a recurrent neural network applicable to the present disclosure.

Referring to FIG. 16, a recurrent neural network (RNN) may have a structure which applies a weighted sum and an activation function by inputting hidden vectors {z₁^{(t-1)}, z₂^{(t-1)}, . . . , z_{H}^{(t-1)}} of an immediately previous timestep t−1 during a process of inputting elements {x₁^{(t)}, x₂^{(t)}, . . . , x_{d}^{(t)}} of a timestep t in a data sequence into a fully connected neural network. The reason why such hidden vectors are forwarded to a next timestep is because information in input vectors at previous timesteps is considered to have been accumulated in a hidden vector of a current timestep.

In addition, referring to FIG. 17, a recurrent neural network may operate in a predetermined timestep order for an input data sequence. Herein, as a hidden vector {z₁⁽¹⁾, z₂⁽¹⁾, . . . , z_{H}⁽¹⁾} at a time of inputting an input vector {x₁^{(t)}, x₂^{(t)}, . . . , x_{d}^{(t)}} of timestep 1 into a recurrent neural network is input together with an input vector {x₁⁽²⁾, x₂⁽²⁾, . . . , x_{d}⁽²⁾} of timestep 2, a vector {z₁⁽²⁾, z₂⁽²⁾, . . . , z_{H}⁽²⁾} of a hidden layer is determined through a weighted sum and an activation function. Such a process is iteratively performed at timestep 2, timestep 3 and until timestep T.

Meanwhile, when a plurality of hidden layers are allocated in a recurrent neural network, this is referred to as a deep recurrent neural network (DRNN). A recurrent neural network is so designed as to effectively apply to sequence data (e.g., natural language processing).

Apart from DNN, CNN and RNN, other neural network cores used as a learning scheme include various deep learning techniques like restricted Boltzmann machine (RBM), deep belief networks (DBN) and deep Q-Network, and these may be applied to such areas as computer vision, voice recognition, natural language processing, and voice/signal processing.

Recently, there are attempts to integrate AI with a wireless communication system, but these are concentrated in an application layer and a network layer and, especially in the case of deep learning, in a wireless resource management and allocation filed. Nevertheless, such a study gradually evolves to a MAC layer and a physical layer, and there are attempts to combine deep learning and wireless transmission especially in a physical layer. As for a fundamental signal processing and communication mechanism, AI-based physical layer transmission means application of a signal processing and communication mechanism based on an AI driver, instead of a traditional communication framework. For example, it may include deep learning-based channel coding and decoding, deep learning-based signal estimation and detection, deep learning-based MIMO mechanism, and AI-based resource scheduling and allocation.

### DETAILED EMBODIMENTS OF THE PRESENT DISCLOSURE

The present disclosure relates to a transceiver having adjustable parameters in a wireless communication system. Specifically, the present disclosure relates to transmitting and receiving signals using a transceiver based on parameters adaptively adjusted according to channel environments, and configuring or building such a transceiver.

A wireless communication system may provide various types of communication services, such as voice or data. Due to significant recent advancements in artificial intelligence (AI), there has been a rapid increase in attempts to integrate AI technology into communication systems. The integration of AI technology may be classified into communications for AI (C4AI), which improves communication technologies to support AI, and AI for communications (AI4C), which utilizes AI to enhance communication performance. For example, in AI4C, there have been attempts to improve design efficiency by replacing channel encoders/decoders with end-to-end auto-encoders. For example, in C4AI, federated learning—a distributed learning technique—enables updating a common predictive model while protecting personal information by sharing only weights or gradients of models with a server, without sharing raw data from devices. For example, methods have also been proposed to distribute loads among devices, network edges, and cloud servers using split inference techniques.

ADNN is trained using training data before being used. Therefore, when applying a DNN to a communication system, training and operating the DNN according to changes in channel environments are required. However, since channels in communication environments have time-varying characteristics, training and operating a DNN according to the channel environment is necessary for its application. To operate DNNs according to channel environments, pre-training and online learning methods are available. Online learning performs DNN training whenever the channel changes during communication. Thus, since continuous training is required to track channel changes, the training overhead is large. In contrast, pre-training involves training DNNs for all channel environments in advance, allowing selective use of the trained DNN suitable for the current channel environment during communication. Therefore, when pre-training is applied, a UE may store pre-trained channel environments in memory or download DNN models in advance for use. In particular, considering all channel environments, applying pre-training to all environments significantly increases DNN parameters, thereby substantially increasing memory size or model download overhead at the UE.

When using pre-trained DNNs in a communication system, continuously classifying channel environments to be trained may result in an infinite number of channel environments to consider. In this case, pre-training cannot be completed. Therefore, when performing pre-training, all channels may be classified into a finite number of channel environments, and training may be performed per classified channel environment.

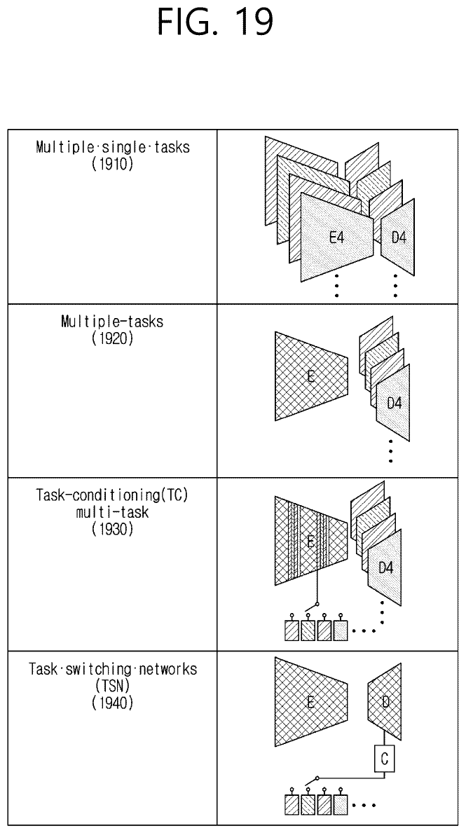

FIGS. 18a and 18b show examples of methods for building DNNs for channel environments according to an embodiment of the present disclosure. In FIGS. 18a and 18b, the vertical axis represents the UE's speed, and the horizontal axis represents delay spread (DS) and power delay profile (PDP). As shown in FIG. 18a, the entire channel environment may be treated as one training environment, and one DNN for all channels may be trained. Alternatively, as shown in FIG. 18b, the entire channel environment may be divided into multiple distinct channel environments, and multiple DNNs corresponding to these environments may be trained. When treating the whole as one channel environment, a higher DNN representation capability is required, increasing the DNN size. On the other hand, when dividing and training multiple channel environments, the channel environment range per DNN is small, allowing more optimal adaptation of the DNN to each channel environment. Further, reducing the channel environment range to be covered allows the use of smaller DNNs.

However, if intended to operate over the entire channel environment, multiple trained DNNs must be selectively used according to the channel environment. Therefore, considering the entire channel environment, utilizing DNNs per divided channel environment may consequently increase the DNN size. In particular, when subdividing channel environments, the number of parameters significantly increases, which may cause difficulties when using pre-trained DNNs. Therefore, when performing pre-training on DNNs corresponding to classified channel environments, a method to reduce the number of trained DNN parameters is required.

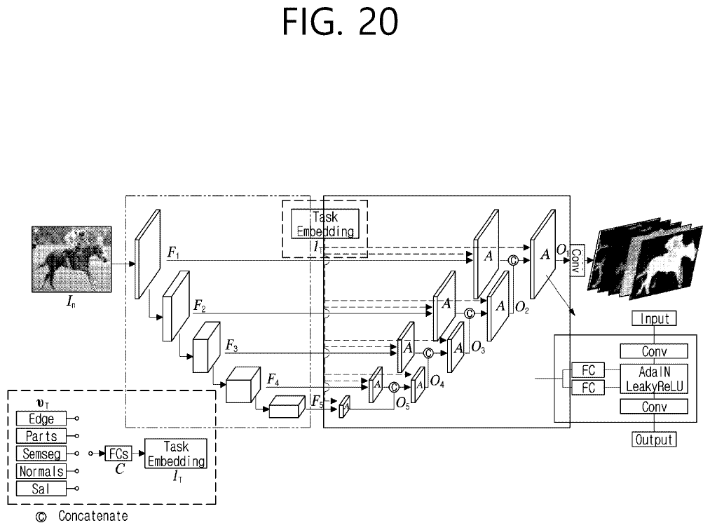

In the DNN research field, research on multi-task learning is ongoing to operate effective DNNs. Among various ongoing studies, a method classified as state-of-art technology is the task switching network (TSN). FIG. 19 shows examples of multi-task learning techniques. FIG. 19 shows multi-tasking solutions studied to date, including TSN. In FIG. 19, the multiple single tasks technique (1910), which is the most basic method, uses separate DNNs for different tasks. The multi-task technique (1920) commonly uses an encoder of the DNN and uses different decoders depending on tasks. The task-conditioning (TC) multi-task technique (1930) is similar to the multi-task technique (1920) in that it uses one encoder and multiple decoders, but differs in selecting different passes per task within the encoder. Finally, the TSN technique (1940) uses one encoder and one decoder. In the TSN technique (1940), the encoder is identical to that of the multi-task technique (1920), but by applying a switch distinguishing tasks to the decoder, the decoder selectively operates according to tasks.

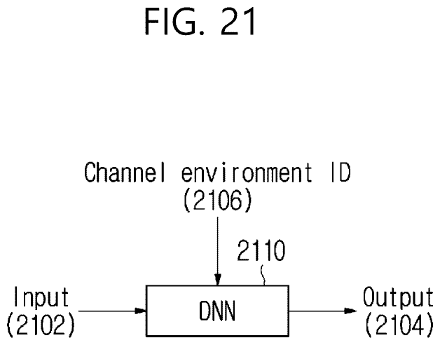

A human neuron may perform multiple functions. The TSN was proposed under the assumption that a neuron of the DNN may also perform multiple functions. The TSN was initially proposed in the field of image processing, and as shown in FIG. 20, may selectively control a DNN using a switch to perform different tasks, such as normalization, edge detection, and semantic information extraction, on an input image. FIG. 20 shows an example of TSN utilization. In FIG. 20, VT denotes a switch vector related to task operation. Along with input data, the switch vector is applied or input to the DNN. The input switch vector passes through a task embedding operation and is delivered to each layer of the decoder, and parameters of the decoder perform operations required for the corresponding task according to the delivered task embedding.

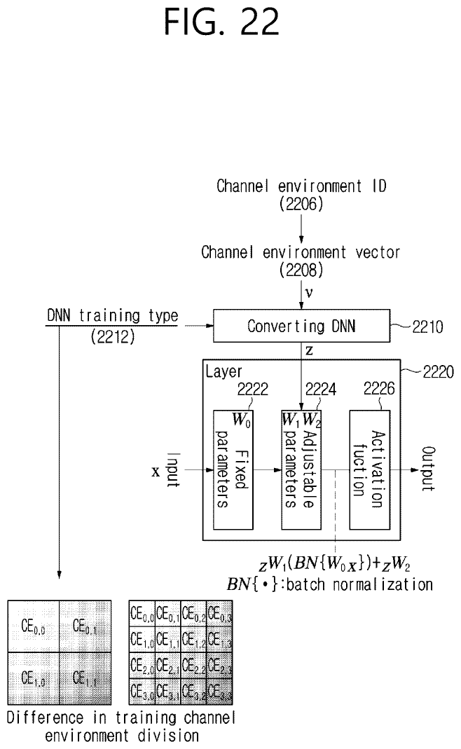

The present disclosure proposes a method in which one DNN adjusts parameters according to a channel environment, and defines an operation procedure for the method. The concept of the DNN according to various embodiments of the present disclosure is shown in FIG. 21 below. FIG. 21 shows the concept of a DNN according to an embodiment of the present disclosure. Referring to FIG. 21, the DNN (2110) generates output data (2104) by performing inference, prediction, or classification based on input data (2102). At this time, in addition to input data (2102), a channel environment identifier (2106) is further input, and the channel environment identifier (2106) includes identification information related to the DNN (2110) per channel environment. The attributes or characteristics of the DNN (2110) may vary depending on the channel environment identifier (2106).

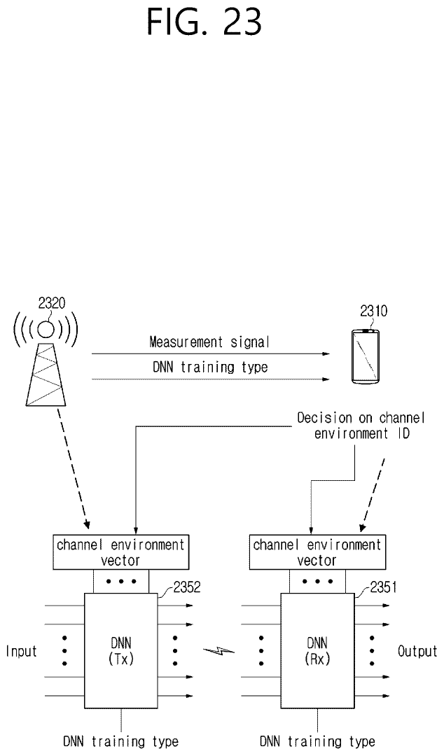

In the present disclosure, FIG. 22 shows an example of a structure of a DNN layer having adjustable parameters according to a channel environment during pre-training operation. FIG. 22 shows an example of a neural network layer structure according to an embodiment of the present disclosure. In FIG. 22, the channel environment identifier (2206) refers to identification information related to a training channel environment selected suitably for an actual channel. The operation mode of the DNN may be determined according to the training channel environment identifier (2206). For example, the DNN training type (2212) is configuration information related to a training channel environment. For example, the DNN training type (2212) may be understood as information indicating how the entire channel is classified into multiple channel environments, representing the resolution for classifying channel environments.

Referring to FIG. 22, a channel environment vector (2208) is generated from the channel environment identifier (2206), and the channel environment vector (2208) is converted into a control value z based on the DNN training type (2212) by a converting DNN (2210). For example, the channel environment vector (2208) is at least a part of input data for the converting DNN (2210), and the control value z is the output data. The converting DNN (2210) may be built through training to generate the control value z from the channel environment vector (2208). Here, a combination of the channel environment vector (2208) and the DNN training type (2212) may be understood as input data for the converting DNN (2210). Alternatively, the converting DNN (2210) may be understood as a TSN whose operation mode varies according to the DNN training type (2212).

The DNN layer (2220) may include fixed parameters (2222), adjustable parameters (2224), and an activation function (2226). For example, the parameters included in the DNN layer (2220) may be divided into fixed parameters W0 unaffected by the channel environment and adjustable parameters affected by the channel environment. Here, the structure including fixed parameters (2222), adjustable parameters (2224), and an activation function (2226) may be understood as applicable to each of all layers or at least some layers of the DNN. According to an embodiment, the adjustable parameters may include z, W1, and W2 as factors, and may be defined by combining z, W1, and W2 according to a predefined rule. For example, the adjustable parameters may be defined as the product of z and W1, and the product of z and W2. The DNN may include multiple layers, and at least some of the multiple layers may have the same structure as the layer (2220) shown in FIG. 22.

Since the DNN according to various embodiments is used by two devices separated by a wireless channel, the transmitting DNN and receiving DNN may be designed to correspond as one pair. When the transmitting DNN and receiving DNN operate as a pair, it is required that the transmitting DNN and receiving DNN operate with the same channel environment identifier and DNN training type. Therefore, the transmitter and receiver may share information to match the channel environment identifier and DNN training type.

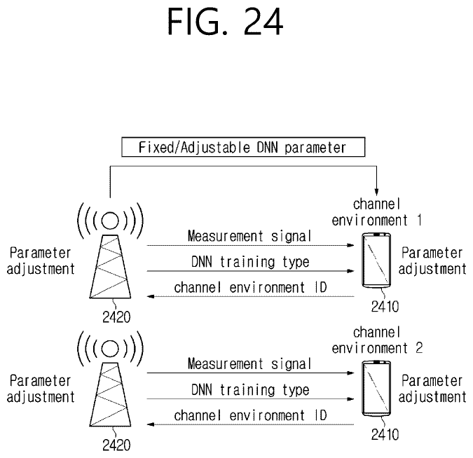

FIG. 23 shows an example of a neural network structure including a transmitting DNN and a receiving DNN according to an embodiment of the present disclosure. FIG. 23 shows a signal flow for operating the transmitting DNN and receiving DNN with the same channel environment identifier and DNN training type when the transmitting DNN and receiving DNN operate as a pair. In FIG. 23, the base station (2320) has a transmitting DNN (2322), and the UE (2310) has a receiving DNN (2312). At this time, one of the base station (2320) and the UE (2310) needs to determine the channel environment identifier and DNN training type and inform the other. In FIG. 23, the base station (2320) delivers the DNN training type to the UE (2310) and transmits a channel measurement signal (e.g., reference signal) to the UE (2310). The UE (2310), which has received the channel measurement signal, determines the channel environment and reports the selected channel environment identifier to the base station (2320).

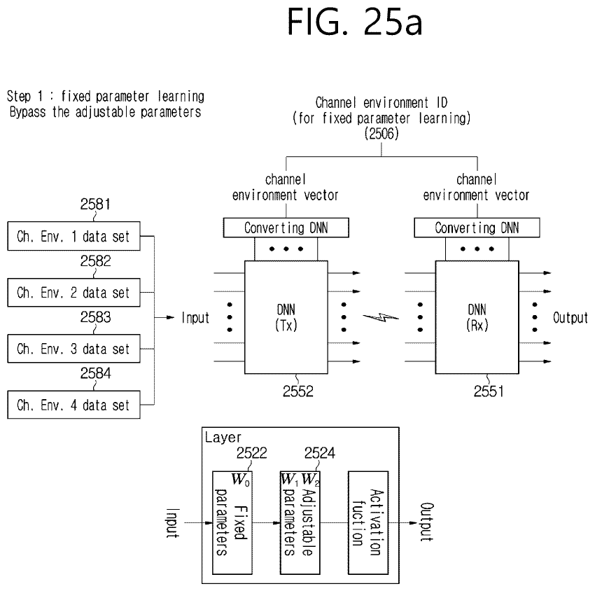

When a DNN having adjustable parameters is used, if the channel environment changes, instead of downloading new DNN parameters, the channel environment identifier is updated, and the DNN applying the updated channel environment identifier may be used. FIG. 24 shows DNN operation based on updating a channel environment identifier according to an embodiment of the present disclosure. Referring to FIG. 24, the DNN may operate by updating the channel environment identifier. Specifically, the UE (2410) determines a training channel environment identifier suitable for the actual channel based on a channel measurement signal, and delivers the determined channel environment identifier to the base station (2420). Accordingly, the base station (2420) adjusts DNN parameters based on the channel environment identifier, and controls the UE (2410) to operate based on the adjusted parameters.

The pre-training process according to various embodiments is as follows. In the following description, an operating entity is referred to as a device, which may be understood as a base station or a UE depending on the situation.
1. The device performs pre-training while changing the DNN training type.
2. The device performs training of the transmitting DNN and receiving DNN for training channel environments corresponding to the DNN training type.

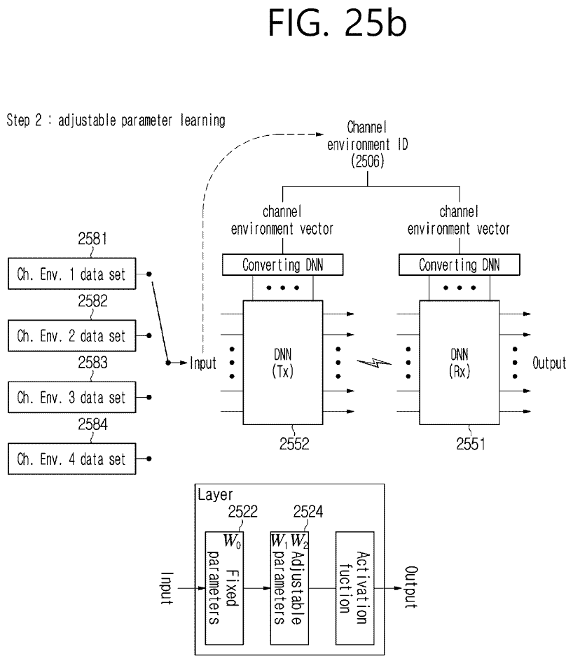

Training of the transmitting DNN and receiving DNN may be performed as shown in FIGS. 25a and 25b. FIGS. 25a and 25b show examples of stepwise training according to an embodiment of the present disclosure. First, in the first training operation as shown in FIG. 25a, the device bypasses the adjustable parameter portion and performs learning for the fixed parameter portion. For bypassing, the channel environment identifier or the channel environment vector may be configured as a value corresponding to bypassing. At this time, the device generates training data by considering various channel environment identifiers within the DNN training type, and performs training. Specifically, the device may generate one training dataset based on the data sets per channel environment (2581 to 2584), and perform training of the transmitting DNN (2552) and receiving DNN (2551) using the training dataset. For example, during the first training operation, the device jointly uses the data sets per channel environment (2581 to 2584). For example, the device may extract data subsets from each of the data sets per channel environment (2581 to 2584) by a predefined ratio, and use the extracted data subsets as training data without distinguishing channel environments. Here, the channel environment identifier (2506) applied to the transmitting DNN (2552) and receiving DNN (2551) may be configured as a value for instructing or controlling to bypass the adjustable parameter portion. For example, the channel environment identifier (2506) may be configured as a value for learning fixed parameters. Accordingly, by performing learning of fixed parameters (2622) among the fixed parameters (2622) and adjustable parameters (2524) included in the layer, the fixed parameters (2622) may be updated.

After performing training for the fixed parameters, in the second training operation as shown in FIG. 25b, the device trains adjustable parameters per channel environment ID. At this time, a converting DNN output generated from the channel environment vector corresponding to the channel environment identifier (2506) is provided as an input to the transmitting DNN (2552) and receiving DNN (2551). Specifically, the device may sequentially perform training of the transmitting DNN (2552) and receiving DNN (2551) using training datasets per channel environment (2581 to 2584). For example, during the second training operation, the device individually uses the datasets per channel environment (2581 to 2584). Here, the channel environment identifier (2506) applied to the transmitting DNN (2552) and receiving DNN (2551) is configured as a value representing the channel environment corresponding to the input dataset (2581, 2582, 2583, or 2884). Accordingly, by performing learning of adjustable parameters (2624) among the fixed parameters (2622) and adjustable parameters (2524) included in the layer, the adjustable parameters (2624) may be updated.

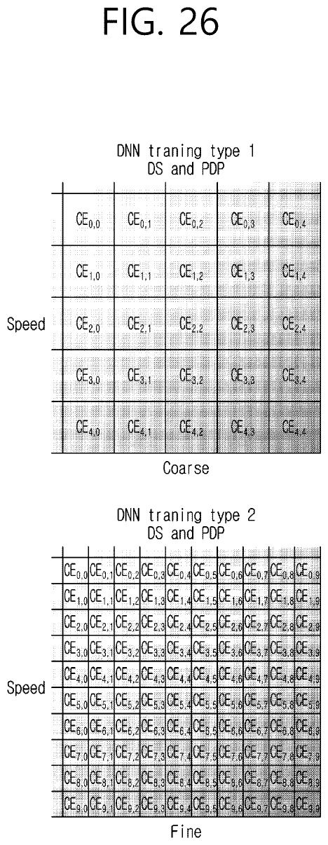

The configuration of training channel environments may vary depending on the DNN training type. For example, as shown in FIG. 26, the range of channel environment parameters considered by each channel environment identifier may differ according to the DNN training type. FIG. 26 shows examples of training types according to an embodiment of the present disclosure. FIG. 26 illustrates two training types (2610, 2620). Referring to FIG. 26, the training types (2610, 2620) differ in the resolution for distinguishing channel environments in a two-dimensional channel environment space where one axis represents the UE's movement speed, and the other axis represents channel characteristics (for example, delay spread (DS) and power delay profile (PDP)). The first training type (2610) distinguishes channel environments with lower resolution compared to the second training type (2620). Accordingly, the first training type (2610) distinguishes channel environments relatively coarsely, whereas the second training type (2620) distinguishes them relatively finely.

Additionally, the relationship between the channel environment identifier and the channel environment vector is represented in the form shown in [Table 2]. A channel vector is allocated to each channel environment identifier.

TABLE 2

| channel | |
|---|---|
| environment | |
| identifier | channel environment vector |
| 0 | v₀ = [v_{0, 0}, v_{0, 2}, . . . v_{0, D}_{_{—}}₀₋₁] |
| 1 | v₀ = [v_{1, 0}, v_{1, 2}, . . . v_{1, D}_{_{—}}₁₋₁] |
| 2 | v₀ = [v_{2, 0}, v_{2, 2}, . . . v_{2, D}_{_{—}}₂₋₁] |
| . . . | . . . |
| B-1 | v₀ = [v_{B-1, 0}, v_{B-1, 2}, . . . v_{B-1, D}_{_{—}}_{B-1}] |

As described above, the transmitting DNN and receiving DNN may be trained to perform multiple tasks. In the embodiments described above, multiple tasks include tasks related to different channel environments. Here, the tasks are transactions related to signal transmission and reception, for example, related to reference signals, data signals, or control signals. Specifically, the tasks may be related to at least one of channel estimation, encoding/decoding, modulation/demodulation, and control signaling. For example, multiple tasks may perform the same type of transaction, but each for different channel environments.

According to an embodiment, multiple tasks may relate to different types of transactions. For example, a first task may include channel estimation, and a second task may include encoding/decoding. In this case, the channel environment identifier may be replaced with a task identifier. According to an embodiment, different types of transactions as well as various channel environments may be supported together. In this case, either a single identifier representing a combination of a channel environment and a task may be used, or a channel environment identifier and a task identifier may be used.

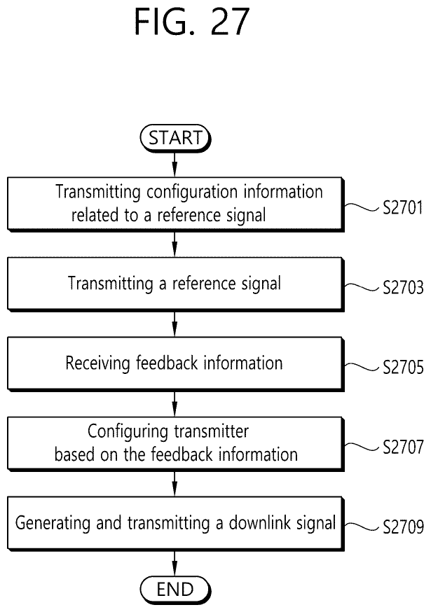

FIG. 27 shows an example of a procedure for transmitting signals using a transmitter according to an embodiment of the present disclosure. FIG. 27 shows an operation method of a base station transmitting downlink signals.

Referring to FIG. 27, in step S2701, the base station transmits configuration information related to reference signals. The configuration information may include at least one of information related to reference signals transmitted for channel measurement (e.g., resources, sequences), information related to channel measurement operation, and information related to feedback (e.g., format, resources, number of feedback instances, period). Additionally, according to various embodiments, the configuration information may include at least one of information indicating the training type of the transmitter and receiver, and information related to parameters of the receiver (e.g., fixed parameters and adjustable parameters).

In step S2703, the base station transmits reference signals. The base station transmits reference signals based on the configuration information. For example, the base station may transmit reference signals based on sequences indicated by the configuration information through resources indicated by the configuration information.

In step S2705, the base station receives feedback information. For example, the base station receives feedback information generated based on the transmitted reference signals. The feedback information includes information related to a channel determined based on the reference signals. According to an embodiment, the feedback information may include information indicating a channel environment (e.g., channel environment identifier). Here, the channel environment is information applied to the transmitter and receiver, used to configure the transmitter and receiver. Specifically, the information indicating the channel environment may be used to determine adjustable parameters of the transmitter and receiver.

In step S2707, the base station configures the transmitter based on the feedback information. According to an embodiment, the base station may configure the transmitter based on the channel environment indicated by the feedback information. Specifically, the base station determines a control value applied to the transmitter based on information indicating the channel environment and the training type. The control value is an auxiliary input value affecting adjustable parameters, for example, it may be used as a factor for determining adjustable parameters. Specifically, the base station may determine adjustable parameters by combining at least one parameter included in the transmitting neural network included in the transmitter and the control value according to a predefined rule. At this time, to determine the control value from information indicating the channel environment, the base station may use a converting neural network different from the transmitting neural network. Here, the transmitting neural network is in a pre-trained state according to the various embodiments described above.

In step S2709, the base station generates and transmits a downlink signal. Specifically, the base station may generate input data corresponding to the purpose of the signal, generate a signal from the input data using the configured transmitter, and then transmit the signal through a wireless channel. At this time, the transmitting neural network included in the transmitter performs at least part of operations for generating the transmission signal, and at least part of the operations processed by the transmitting neural network may vary according to specific embodiments. For example, the output of the transmitting neural network may be values of physical signals to be transmitted (e.g., OFDM signal values) or intermediate values requiring additional processing (e.g., encoding results, symbol modulation results).

In the embodiment described with reference to FIG. 27, configuration information including at least one of information indicating the training type or parameters of the receiver is transmitted. Furthermore, the configuration information is transmitted prior to transmitting the reference signal, and may include configurations related to the reference signal. However, according to another embodiment, at least one of information indicating the training type or parameters of the receiver may be signaled separately from the configurations related to the reference signal. For example, at least one of information indicating the training type or parameters of the receiver may be transmitted via system information or dedicated signaling. Also, according to another embodiment, at least one of information indicating the training type or parameters of the receiver may be transmitted after transmitting the reference signal.

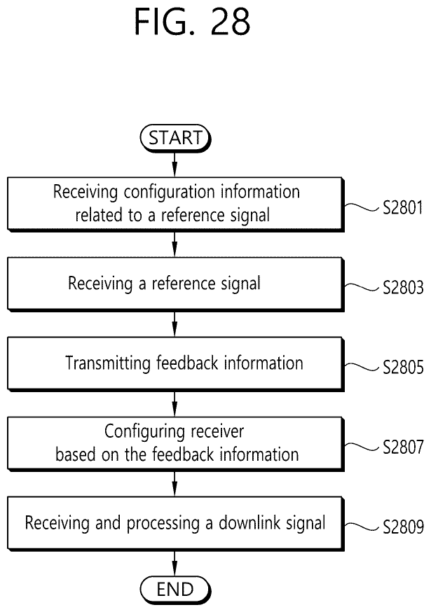

FIG. 28 shows an example of a procedure for receiving signals using a receiver according to an embodiment of the present disclosure. FIG. 28 shows an operation method of a UE receiving downlink signals.

Referring to FIG. 28, in step S2801, the UE receives configuration information related to reference signals. The configuration information may include at least one of information related to reference signals transmitted for channel measurement (e.g., resources, sequences), information related to channel measurement operation, and information related to feedback (e.g., format, resources, number of feedback instances, period). Additionally, according to various embodiments, the configuration information may include at least one of information indicating the training type of the transmitter and receiver, and information related to parameters of the receiver (e.g., fixed parameters and adjustable parameters).

In step S2803, the UE receives reference signals. The UE receives reference signals based on the configuration information. For example, the UE may receive reference signals based on sequences indicated by the configuration information through resources indicated by the configuration information. Through this, the UE may obtain received values or measurement values for the reference signals. Additionally, according to an embodiment, the UE may determine the current channel environment experienced by the UE based on received values or measurement values for the reference signals. Specifically, the UE may determine the UE's movement speed and statistical characteristics of the channel (e.g., delay spread (DS), power delay profile (PDP)), and classify the channel environment based on the determined movement speed and statistical characteristics of the channel.

In step S2805, the UE transmits feedback information. For example, the UE transmits feedback information generated based on the transmitted reference signals to the base station. The feedback information includes information related to a channel determined based on the reference signals. According to an embodiment, the feedback information may include information indicating a channel environment (e.g., channel environment identifier). Here, the channel environment is information applied to the transmitter and receiver, used to configure the transmitter and receiver. Specifically, the information indicating the channel environment may be used to determine adjustable parameters of the transmitter and receiver.

In step S2807, the UE configures the receiver based on the feedback information. For example, the UE may configure the receiver based on the channel environment indicated by the feedback information. Specifically, the UE determines a control value applied to the receiver based on information indicating the previously determined channel environment and the training type. The control value is an auxiliary input value affecting adjustable parameters, for example, it may be used as a factor for determining adjustable parameters. Specifically, the UE may determine adjustable parameters by combining at least one parameter included in the receiving neural network included in the receiver and the control value according to a predefined rule. At this time, to determine the control value from information indicating the channel environment, the UE may use a converting neural network different from the receiving neural network. Here, the receiving neural network is in a pre-trained state according to the various embodiments described above.

In step S2809, the UE receives and processes a downlink signal. Specifically, the UE may receive a signal via a wireless channel and obtain output data corresponding to the purpose of the received signal. At this time, the receiving neural network included in the receiver performs at least some of the operations for processing the received signal, and at least some of the operations processed by the receiving neural network may vary depending on specific embodiments. For example, the input data to the receiving neural network may be the values of the received physical signals (e.g., OFDM signal values), or intermediate values obtained after partial processing (e.g., OFDM demodulation results, symbol demodulation results).

In the embodiment described with reference to FIG. 28, configuration information including at least one of information indicating a training type or parameters of the receiver is received. Furthermore, the configuration information is received prior to receiving the reference signals and may include configurations related to the reference signals. However, according to other embodiments, at least one of information indicating a training type or parameters of the receiver may be signaled separately from the configurations related to the reference signals. For example, at least one of information indicating a training type or parameters of the receiver may be received via system information or through dedicated signaling. Additionally, according to other embodiments, at least one of information indicating a training type or parameters of the receiver may be received after receiving the reference signals.

The embodiments described with reference to FIGS. 27 and 28 relate to downlink transmission. However, the above embodiments may also be applied to links other than the downlink, for example, an uplink or sidelink.

In the case of an uplink, the base station transmits configuration information and reference signals, configures the receiver, and may process uplink signals using the configured receiver. Correspondingly, the UE receives the configuration information and reference signals, transmits information related to the channel environment, configures the transmitter, and may generate and transmit uplink signals using the configured transmitter.

Alternatively, the base station transmits the configuration information, receives the uplink reference signals, transmits information related to the channel environment, configures the receiver, and may receive and process uplink signals using the configured receiver. Correspondingly, the UE receives configuration information, transmits uplink reference signals, receives information related to the channel environment, configures the transmitter, and may generate and transmit uplink signals using the configured transmitter.

In the case of sidelink, one UE performs the operations of the above-described base station, and the other UE may perform the operations of the above-described UE. Alternatively, the base station may be involved in at least part of the control signaling.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving, from a base station, configuration information related to reference signals;
receiving the reference signals;
generating feedback information by using the reference signals; and
transmitting, to the base station, the feedback information,
wherein the feedback information includes information representing a channel environment for determining adjustable parameters included in a receiver of the UE and a transmitter of the base station.

2. The method of claim 1, further comprising:
configuring the receiver based on the information representing the channel environment; and
processing signals received from the base station by using the receiver.

3. The method of claim 1, further comprising:
receiving information representing a training type related to training for the receiver of the UE and the transmitter of the base station,
wherein the training type representing a resolution for classifying channel environments.

4. The method of claim 3, further comprising:
determining at least one factor of adjustable parameters of the receiver based on the information representing the training type and the information representing the channel environment.

5. The method of claim 1,
wherein the channel environment is determined based on a moving speed of the UE and statistical characteristics of a channel between the base station and the UE,
wherein the statistical characteristics include at least one of delay spread (DS) or power delay profile (PDP).

6. The method of claim 1,
wherein the receiver includes a neural network including at least one layer,
wherein the at least one layer includes at least one fixed parameter, at least one adjustable parameter, and an activation function,
wherein the at least one adjustable parameter is defined as a combination of a control value determined based on the information representing the channel environment and at least one parameter.

7. The method of claim 6,
wherein the receiver is trained through pre-training,
wherein the pre-training includes a first training operation performing training for the at least one fixed parameter while configuring the at least one adjustable parameter to a bypass state, and a second training operation performing training for the at least one adjustable parameter after the first training operation.

8. The method of claim 7,
wherein the first training operation is performed by jointly using training data per channel environment,
wherein the second training operation is performed by separately using training data per channel environment.

9. A method comprising:
transmitting, to a user equipment (UE), configuration information related to reference signals;
transmitting the reference signals; and
receiving, from the UE, feedback information,
wherein the feedback information includes information representing a channel environment for determining adjustable parameters included in a receiver of the UE and a transmitter of the base station.

10. The method of claim 9, further comprising:
configuring the transmitter based on the information representing the channel environment; and
processing signals transmitted to the UE by using the transmitter.

11. The method of claim 9, further comprising:
transmitting information representing a training type related to training for the receiver of the UE and the transmitter of the base station,
wherein the training type representing a resolution for classifying channel environments.

12. The method of claim 11, further comprising:
determining at least one factor of adjustable parameters of the receiver based on the information representing the training type and the information representing the channel environment.

13. The method of claim 9,
wherein the channel environment is determined based on a moving speed of the UE and statistical characteristics of a channel between the base station and the UE,
wherein the statistical characteristics include at least one of delay spread (DS) or power delay profile (PDP).

14. A user equipment (UE) comprising:
a transceiver; and
a processor connected to the transceiver,
wherein the processor is configured to perform operations comprising:
receiving, from a base station, configuration information related to reference signals;
receiving the reference signals;
generating feedback information by using the reference signals; and
transmitting, to the base station, the feedback information,
wherein the feedback information includes information representing a channel environment for determining adjustable parameters included in a receiver of the UE and a transmitter of the base station.
